(19) United States
(12) Patent Application Publication
(10) Pub. No.: US 2014/0360985 A1
(43) Pub. Date: Dec. 11, 2014

(54) SWITCH

(71) Applicants: FUJI ELECTRIC FA COMPONENTS & SYSTEMS CO., LTD., Chuo-ku, Tokyo (JP); FUJI ELECTRIC CO., LTD., Kawasaki-shi, Kanagawa (JP)

(72) Inventors: Kouetsu Takaya, Kounosu-shi (JP); Kenji Suzuki, Kounosu-shi (JP); Yoshinobu Sugata, Miura-shi (JP); Masaharu Furukawa, Kounosu-shi (JP)

(21) Appl. No.: 14/363,183

(22) PCT Filed: Mar. 4, 2013
(86) PCT No.: PCT/JP2013/001320

§ 371 Date: Jun. 5, 2014

(30) Foreign Application Priority Data
Mar. 12, 2012 (JP) 2012-055157

(51) Int. Cl. H01H 33/56; H01H 33/02; H01H 33/64

(52) U.S. Cl. CPC H01H 33/565; H01H 33/64; H01H 33/025; H01H 2223/006
USPC 218/156

(57) ABSTRACT

A switch includes a pair of fixed contacts disposed at a predetermined distance from each other; a movable contact arranged to be capable of contacting with and separating from the pair of fixed contacts; and an arc extinguishing container internally mounted with the pair of fixed contacts and the movable contact. The arc extinguishing container includes a resin container having a terminal retention plate portion adhesively bonded a pair of external connection terminals, and a side plate portion extending downward from an outer circumferential portion of the terminal retention plate portion, and formed with an open face, and a metal bucket-shaped body internally mounted with the movable contact and the pair of fixed contacts inserted into the side plate portion of the resin container. The are extinguishing container is formed by bonding the resin container and the metal bucket-shaped body to each other by an adhesive agent.

### TECHNICAL FIELD

The present invention relates to a switch in which fixed contacts and a movable contact disposed to be capable of contacting with and separating from the fixed contacts are internally mounted in an arc extinguishing container.

### BACKGROUND ART

This kind of switch has a terminal sealing structure in which terminals are inserted into terminal holes provided in a metal housing and a sealing material is injected and solidified so as to seal the terminals. As the terminal sealing structure, there has been known a terminal sealing structure which is used in an opening/closing device for opening/closing a circuit, such as an electromagnetic relay, a switch or a timer, and in which an inorganic filler is added to a liquid thermosetting polymer to form the sealing material whose thermal expansion coefficient is set to be not smaller than the linear expansion coefficient of the metal housing (for example, see Patent Literature 1).

### CITATION LIST

### Patent Literature

PTL 1: JP-A-2005-15773

### SUMMARY OF INVENTION

### Technical Problem

In a background-art example described in the aforementioned Patent Literature 1, an insulating case is disposed inside a cylindrical sealing case block, and a sealing cover is disposed on an upper end of the sealing case block. Terminal holes are formed in the sealing cover, and terminals are disposed inside the terminal holes. In this state, a sealing material is injected and solidified between the terminal holes and the terminals.

In the case where the sealing material is thus injected and solidified between the terminal holes and the terminals after the terminal holes are formed in the sealing cover and the terminals are disposed in the terminal holes, relatively large injection pressure is necessary for spreading the sealing material perfectly all over the injection places. Therefore, the portions where the sealing material should be injected must be formed accurately enough to prevent the sealing material from leaking. Thus, there is an unsolved problem that the molding cost increases.

Accordingly, the invention has been accomplished in focus on the unsolved problem inherent in the background-art example. An object of the invention is to provide a switch in which an arc extinguishing container can be formed easily.

### Solution to Problem

In order to achieve the object, in a first aspect of the switch according to the invention, provided is a switch in which a pair of fixed contacts disposed at a predetermined distance from each other and a movable contact arranged to be capable of contacting with and separating from the pair of fixed contacts are internally mounted in an arc extinguishing container. The arc extinguishing container is formed by bonding a resin container and a metal bucket-shaped body to each other by an adhesive agent. The resin container has a terminal retention plate portion which retains a pair of external connection terminals as constituents of the pair of fixed contacts by adhesive bonding, and a side plate portion which extends downward from an outer circumferential portion of the terminal retention plate portion. An opposite side of the resin container to the terminal retention plate portion is formed as an open face. The bucket-shaped body is internally mounted with the pair of fixed contacts inserted into the side plate portion of the resin container and the movable contact. The bucket-shaped body has an open lower side.

According to the configuration, when only a synthetic resin is used to keep the airtightness of the arc extinguishing container, slow leak may increase as compared with that in the case of ordinary use of ceramic. However, the leak performance can be made equivalent to that of ceramic when the metal bucket-shaped body is placed inside the resin container.

Moreover, the resin container and the bucket-shaped body are bonded to each other by an adhesive agent. Accordingly, it is not necessary to inject the adhesive agent with pressure applied like a sealing agent. Thus, the resin container and the bucket-shaped body can be bonded to each other easily.

In addition, in a second aspect of the switch according to the invention, the terminal retention plate portion has a pair of terminal insertion holes inserted with the pair of external connection terminals, and a pair of annular protruding portions formed continuously to the pair of terminal insertion holes so as to protrude from the bottoms thereof and fitted into a pair of terminal insertion holes formed in a top plate portion of the bucket-shaped body.

According to this second aspect, the pair of terminal insertion holes inserted with the external connection terminals, and the pair of annular protruding portions connected continuously to the pair of terminal insertion holes and fitted into the pair of terminal insertion holes formed in the bucket-shaped body are formed in the terminal retention plate portion of the resin container. When the annular protruding portions are fitted into the terminal insertion holes of the bucket-shaped body, the pair of external connection terminals can be insulated from the metal bucket-shaped body. In addition, in a third aspect of the switch according to the invention, an insulating cylinder surrounding the pair of fixed contacts and the movable contact so as to form an arc extinguishing chamber is disposed on an inner side surface of the bucket-shaped body.

According to this third aspect, the insulating cylinder is disposed on the inner side surface of the metal bucket-shaped body. Accordingly, the arc extinguishing chamber for extinguishing arcs which occur when the movable contact is separated from the pair of fixed contacts is formed by the insulating cylinder.

In addition, in a fourth aspect of the switch according to the invention, tapered portions each of which gradually increases in diameter from an outer surface side toward an inner surface side are formed in the pair of terminal insertion holes in the terminal retention plate portion of the resin container and adhesive agent injection portions each shaped like a wedge in section are formed between the tapered portions and the external connection terminals.

According to the fourth aspect, the tapered portions are formed in the pair of terminal insertion holes formed in the terminal retention plate portion of the resin container and the adhesive agent injection portions are formed between the tapered portions and the external connection terminals. Accordingly, when an adhesive agent is injected into the adhesive agent injection portions and solidified, strong adhesive bonding can be attained between the terminal retention plate portion of the resin container and the pair of external connection terminals.

In addition, in a fifth aspect of the switch according to the invention, a tapered portion having an opposing length which increases gradually from the terminal retention plate portion toward the open face is formed in an inner surface of the side plate portion of the resin container, and an adhesive agent injection portion shaped like a wedge is formed between the tapered portion and a side surface of the bucket-shaped body.

According to the fifth aspect, when the metal bucket-shaped body is inserted into the side plate portion of the resin container, the adhesive agent injection portion shaped like a wedge in section is formed between the side plate portion and the side surface of the bucket-shaped body and an adhesive agent is injected into the adhesive agent injection portion and solidified. Thus, the resin container and the metal bucket-shaped body can be fixed to each other surely by the adhesive agent.

### Advantageous Effects of Invention

According to the invention, the metal bucket-shaped body is disposed on the inner side of the resin container so that equivalent leak performance to that of ceramic can be attained. Moreover, the resin container and the bucket-shaped body are bonded to each other by an adhesive agent. Accordingly, it is not necessary to inject the bonding agent with pressure applied like a sealing agent. Thus, the resin container and the bucket-shaped body can be adhesively bonded to each other easily. Accordingly, an arc extinguishing container of a switch can be formed easily.

### BRIEF DESCRIPTION OF DRAWINGS

FIG. 1 is a perspective view showing an embodiment in the case where the invention is applied to an electromagnetic contactor.

FIG. 2 is a longitudinal sectional view of FIG. 1.

FIG. 3 is a perspective view showing a resin container and external connection terminals.

FIG. 4 is a perspective view showing a bucket-shaped body and an upper magnetic yoke.

FIGS. 5(a)-5(c) are views showing an insulating cover of a contact device, in which FIG. 5(a) is a perspective view, FIG. 5(b) is a plan view before mounting, and FIG. 5(c) is a plan view after mounting.

FIGS. 6(a)-6(c) are explanatory views showing a method for mounting the insulating cover.

FIG. 7 is a sectional view taken along the line A-A of FIG. 2.

FIGS. 8(a)-8(c) are explanatory views for explaining arc extinction using arc extinguishing permanent magnets which can be applied to the invention.

FIGS. 9(a)-9(c) are explanatory views for explaining arc extinction when the arc extinguishing permanent magnets are disposed outside an insulating case.

FIGS. 10(a)-10(b) are views showing a modification of a contact mechanism in the contact device which can be applied to the invention, in which FIG. 10(a) is a sectional view, and FIG. 10(b) is a perspective view.

FIGS. 11(a), 11(b) are views showing another modification of the contact mechanism in the contact device which can be applied to the invention, in which FIG. 11(a) is a sectional view, and FIG. 11(b) is a perspective view.

### DESCRIPTION OF EMBODIMENTS

Embodiments of the invention will be described below with reference to the drawings.

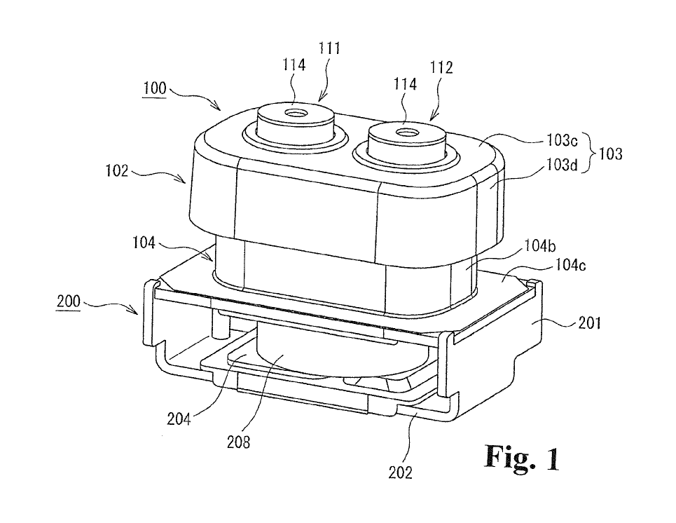

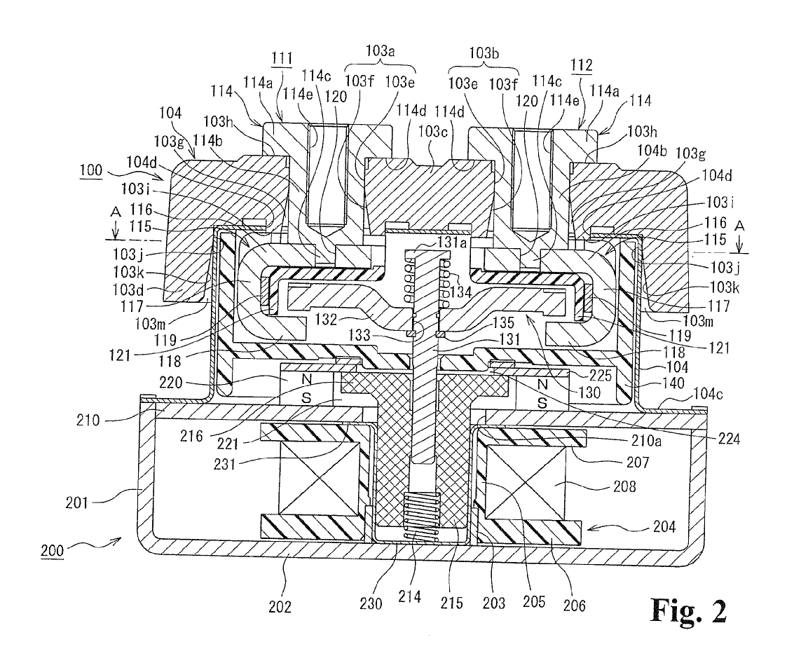

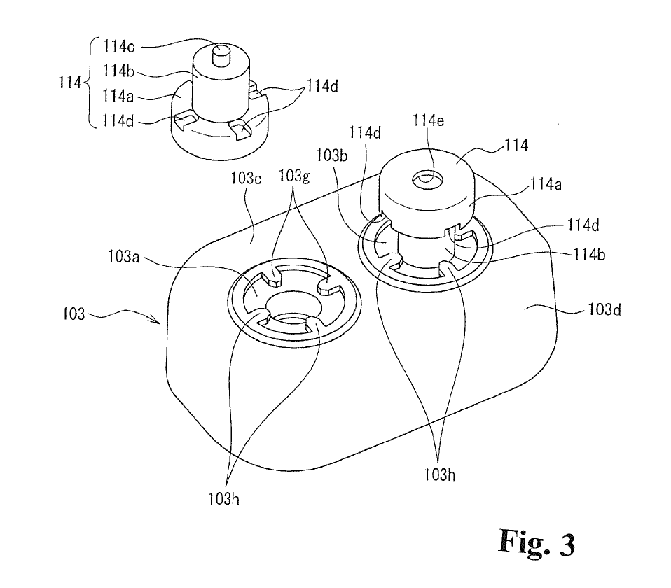

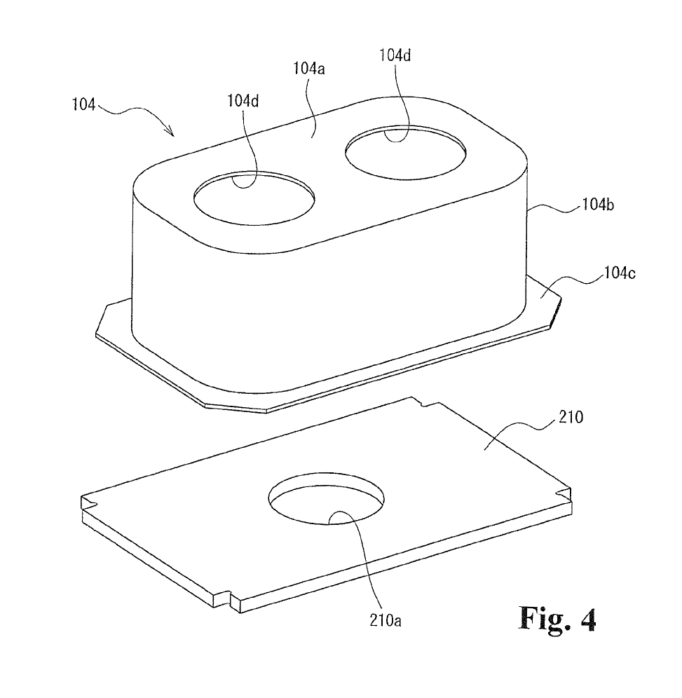

FIG. 1 is a perspective view showing an overall configuration in the case where the invention is applied to an electromagnetic switch. FIG. 2 is a longitudinal sectional view of FIG. 1. FIG. 3 is a perspective view showing a resin container. FIG. 4 is a perspective view showing a bucket-shaped body. In these FIGS. 1 to 4, the reference numeral 10 designates an electromagnetic contactor as a switch. This electromagnetic contactor 10 includes a contact device 100 in which a contact mechanism is disposed, and an electromagnet unit 200 which drives the contact device 100.

As apparent from FIGS. 1 to 4, the contact device 100 has an arc extinguishing container 102 in which the contact mechanism 101 is received. As shown in FIGS. 1 and 2, the arc extinguishing container 102 is provided with a resin container 103 which is formed by injection-molding a synthetic resin, and a metal bucket-shaped body 104 which is inserted into the resin container 103.

Particularly as apparent from FIG. 2, the resin container 103 includes a terminal retention plate portion 103c and a side plate portion 103d. The terminal retention plate portion 103c is comparatively thick. Terminal insertion holes 103a and 103b are formed in the terminal retention plate portion 103c. A pair of fixed contacts 111 and 112 which will be described later is inserted through the terminal insertion holes 103a and 103b while a predetermined distance is kept therebetween. The side plate portion 103d is shaped like a square cylinder extending integrally with the terminal retention plate portion 103c and downward from an outer circumferential portion of the terminal retention plate portion 103c.

The terminal insertion holes 103a and 103b formed in the terminal retention plate portion 103c have cylindrical support surfaces 103e on their upper end sides. Each cylindrical support surface 103e has an inner diameter substantially equal to an outer diameter of each of cylinder portions of external connection terminals 114. The external connection terminals 114 form the pair of fixed contacts 111 and 112. In addition, in each of the terminal insertion holes 103a and 103b, a tapered portion 103f is formed continuously to the lower end side of the cylindrical support surface 103e so that the diameter of the tapered portion 103f increases as it goes downward. An adhesive agent injection portion 103g shaped like a wedge in section is formed between each tapered portion 103f and each external connection terminal 114.

Particularly as apparent in FIG. 3, for example, positioning pieces 103h protruding slightly inward and arranged at intervals of 90° are formed on the upper surface side of each of the terminal insertion holes 103a and 103b. Rotation of the external connection terminals 114 around the center shafts can be prevented when the positioning pieces 103h are engaged with engagement grooves 114d formed in the external connection terminals 114 which will be described later. Further, an annular rib 103i shaped like a ring and protruding slightly downward is formed on the lower surface side of each of the terminal insertion holes 103a and 103b.

In addition, the side plate portion 103d has a perpendicular fitting surface 103j on its upper end side where the inner circumferential surface of the side plate portion 103d contacts the terminal retention plate portion 103c. A tapered portion 103k is formed on the lower end side of the fitting surface 103j and continuously thereto so that the opposing length between the opposed surfaces of the tapered portion 103k increases as it goes downward. An adhesive agent injection portion 103m shaped like a wedge in section is formed between the tapered portion 103k and a side plate portion 104b of the bucket-shaped body 104 which will be described later.

Further, the external connection terminals 114 forming the fixed contacts 111 and 112 which will be described later are inserted into the terminal insertion holes 103a and 103b of the resin container 103 and the engagement grooves 114d of the external connection terminals 114 are engaged with the positioning pieces 103h so that the external connection terminals 114 can be prevented from rotating. After that, an adhesive agent is injected into the adhesive agent injection portions 103g and solidified.

The bucket-shaped body 104 is formed by integrally molding a metal such as stainless steel or aluminum. As shown in FIG. 4, the bucket-shaped body 104 includes a top plate portion 104a substantially shaped like a rectangle, a side plate portion 104b shaped like a square cylinder and extending downward from the outer circumferential side of the top plate portion 104a, and a flange portion 104c protruding outward from a lower end surface of the side plate portion 104b. Terminal insertion holes 104d into which the pair of ring-shaped ribs 103i of the resin container 103 is fitted are formed in the top plate portion 104a.

Due to sealing using brazing or welding, the flange portion 104c of the bucket-shaped body 104 is airtightly fixed to an outer circumferential side upper surface of an upper magnetic yoke 210 of the electromagnet unit 200 which will be described later. The bucket-shaped body 104 is inserted into the side plate portion 103d of the resin container 103. Thus, when an adhesive agent is injected into the wedge-shaped adhesive agent injection portion 103m formed between the tapered portion 103k of the side plate portion 103d of the resin container 103 and the side plate portion 104b of the bucket-shaped body 104 and solidified, the resin container 103 and the bucket-shaped body 104 are integrated with each other airtightly.

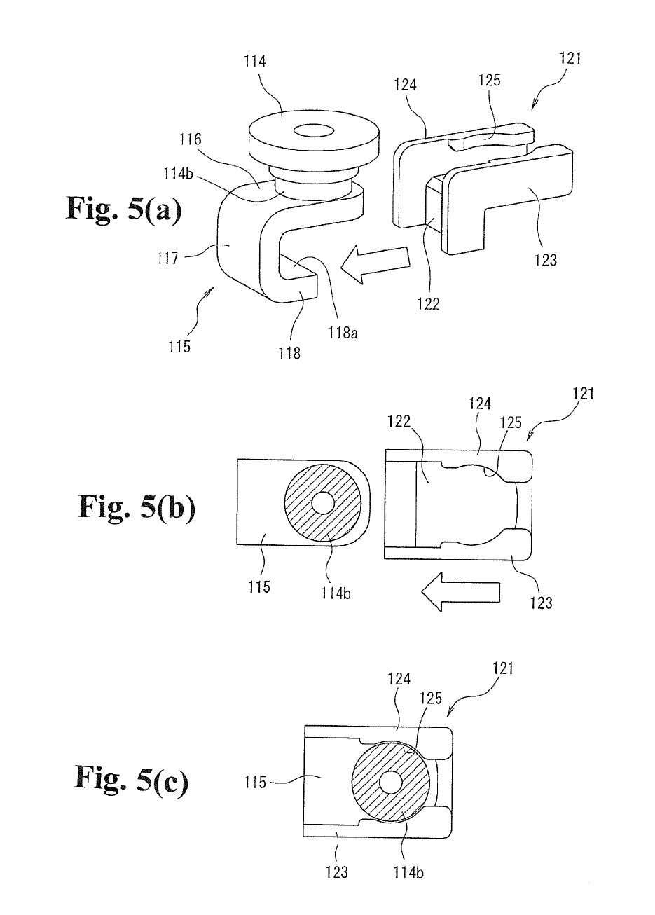

As shown in FIG. 2, the contact mechanism 101 is provided with the pair of fixed contacts 111 and 112 inserted into the terminal insertion holes 103a and 103b of the terminal retention plate portion 103c of the resin container 103 and fixed thereto by adhesive bonding. As shown in FIG. 5(a), each of these fixed contacts 111 and 112 is provided with the external connection terminal 114 and a C-shaped portion 115. The external connection terminals 114 have flange portions 114a which protrude outward at the upper ends of the external connection terminals 114 when the external connection terminals 114 are inserted into the terminal insertion holes 103a and 103b of the terminal retention plate portion 103c. The C-shaped portions 115 are connected to the external connection terminals 114 and disposed symmetrically on the lower surface side of the terminal retention plate portion 103c while the C-shaped portions 115 are open on their inner sides.

Each of the C-shaped portions 115 has an upper plate portion 116, an intermediate plate portion 117, and a lower plate portion 118. The upper plate portion 116 extends outward along the lower surface of the terminal retention plate portion 103c. The intermediate plate portion 117 extends downward from an outer end portion of the upper plate portion 116. The lower plate portion 118 extends inward from the lower end side of the intermediate plate portion 117 and in parallel with the upper plate portion 116. That is, the lower plate portion 118 extends in the direction in which the fixed contacts 111 and 112 are opposed to each other. Thus, each C-shaped portion 115 is formed into a C shape in which the upper plate portion 116 is added to an L shape formed by the intermediate plate portion 117 and the lower plate portion 118.

Here, as shown in FIG. 2, the external connection terminal 114 and the C-shaped portion 115 are fixed to each other, for example, by brazing in a state in which a pin 114c formed to protrude on a lower end surface of the external connection terminal 114 is inserted into a through hole 120 formed in the upper plate portion 116 of the C-shaped portion 115. Incidentally, the method for fixing the external connection terminal 114 and the C-shaped portion 115 to each other is not limited to brazing. Alternatively, the pin 114c may be fitted into the through hole 120 or the pin 114c which is threaded externally may be screwed into the through hole 120 which is threaded internally.

An insulating cover 121 made of a synthetic resin material and provided for suppressing generation of an arc is mounted onto the C-shaped portion 115 of each of the fixed contacts 111 and 112. As shown in FIGS. 5(a) and 5(b), inner circumferential surfaces of the upper plate portion 116 and the intermediate plate portion 117 of the C-shaped portion 115 are covered with the insulating cover 121.

The insulating cover 121 is provided with an L-shaped plate portion 122, side plate portions 123 and 124, and fitting portions 125. The L-shaped plate portion 122 extends along the inner circumferential surfaces of the upper plate portion 116 and the intermediate plate portion 117. The side plate portions 123 and 124 extend upward and outward from front and rear end portions of the L-shaped portion 122 respectively so that side surfaces of the upper plate portion 116 and the intermediate plate portion 117 of the C-shaped portion 115 are covered with the side plate portions 123 and 124. The fitting portions 125 are formed to extend inward from upper ends of the side plate portions 123 and 124 and fitted to a small diameter portion 114b formed in each of the external connection terminals 114 of the fixed contacts 111 and 112.

Accordingly, the insulating covers 121 are mounted onto the fixed contacts 111 and 112 as follows. As shown in FIGS. 5(a) and 5(b), the insulating covers 121 are set in a state in which the fitting portions 125 are opposed to the small diameter portions 114b of the external connection terminals 114 of the fixed contacts 111 and 112. Next, as shown in FIG. 5(c), the insulating covers 121 are pushed toward the small diameter portions 114b side of the external connection terminals 114, so that the fitting portions 125 are engaged with the small diameter portions 114b of the external connection terminals 114.

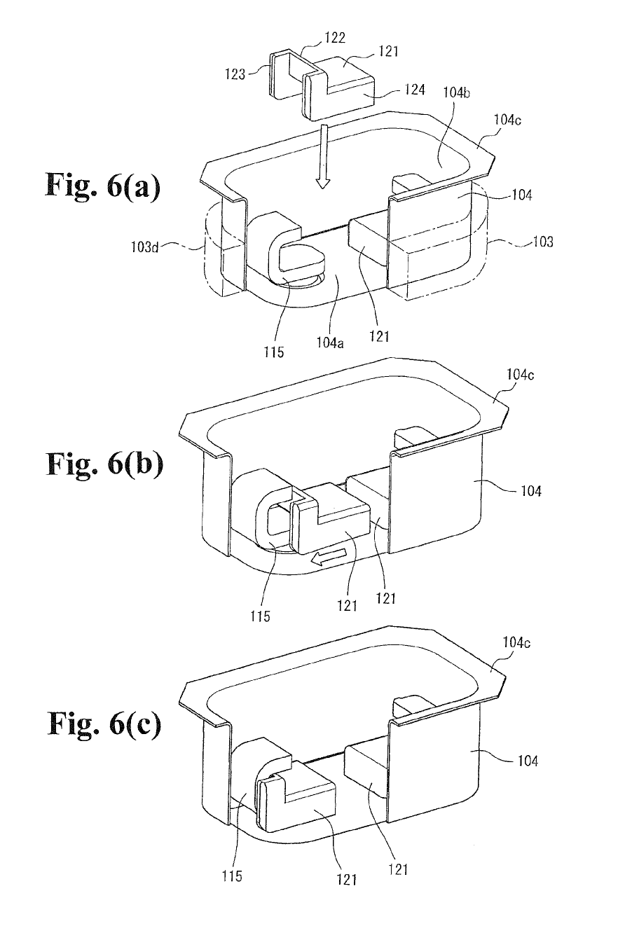

Practically, as shown in FIG. 6(a), the insulating covers 121 in FIGS. 5(a) to 5(c) turned upside down are inserted between the fixed contacts 111 and 112 from an upper opening portion in a state in which the resin container 103 and the bucket-shaped body 104 to which the fixed contacts 111 and 112 have been attached are arranged with the resin container 103 located in the lower side.

Next, the insulating covers 121 are pushed outward as shown in FIG. 6(c) in a state in which the fitting portions 125 are contacting a fixed contact supporting insulating substrate 105 as shown in FIG. 6(b). Thus, the fitting portions 125 are fitted and fixed to the small diameter portions 114b of the external connection terminals 114 of the fixed contacts 111 and 112.

When the insulating covers 121 are mounted thus on the C-shaped portions 115 of the fixed contacts 111 and 112, only the upper surface sides of the lower plate portions 118 are exposed in the inner circumferential surfaces of the C-shaped portions 115 so as to be formed as contact point portions 118a.

A movable contact 130 is arranged so that opposite end portions of the movable contact 130 are disposed inside the C-shaped portions 115 of the fixed contacts 111 and 112. The movable contact 130 is supported by a connecting shaft 131 fixed to a movable plunger 215 of the electromagnet unit 200 which will be described later. As shown in FIG. 2, the movable contact 130 protrudes downward in the center portion in the vicinity of the connecting shaft 131 so as to form a recessed portion 132. A through hole 133 is formed in the recessed portion 132 so that the connecting shaft 131 can be inserted through the through hole 133.

A flange portion 131a is formed in an upper end of the connecting shaft 131 to protrude outward. The connecting shaft 131 is inserted through a contact spring 134 from its lower end side and then inserted through the through hole 133 of the movable contact 130. An upper end of the contact spring 134 is made to abut against the flange portion 131a and the movable contact 130 is positioned, for example, by means of a C-ring 135 so that a predetermined urging force can be obtained from the contact spring 134.

When the movable contact 130 is OFF, contact point portions at opposite ends thereof are separated from the contact point portions 118a of the lower plate portions 118 of the C-shaped portions 115 of the fixed contacts 111 and 112 while keeping a predetermined distance therebetween. In addition, the movable contact 130 is set so that the contact point portions at the opposite ends of the movable contact 130 can contact the contact point portions 118a of the lower plate portions 118 of the C-shaped portions 115 of the fixed contacts 111 and 112 by predetermined contact pressure given by the contact spring 134 when the movable contact 130 is in an ON position.

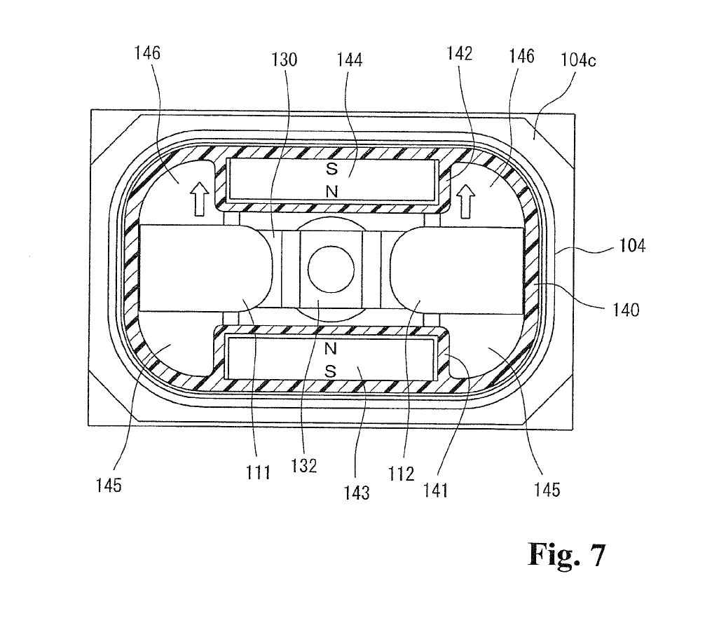

For example, an insulating cylinder 140 made of a synthetic resin is further disposed on an inner circumferential surface of the bucket-shaped body 104 of the arc extinguishing container 102. As shown in FIG. 7, magnet storage pockets 141 and 142 are formed in the insulating cylinder 140 so that the magnet storage pockets 141 and 142 are located in positions facing side surfaces of the movable contact 130. Arc extinguishing permanent magnets 143 and 144 are inserted and fixed into the magnet storage pockets 141 and 142.

The arc extinguishing permanent magnets 143 and 144 are magnetized so that faces of the permanent magnets 143 and 144 facing each other in a thickness direction have the same pole, such as an N pole. In addition, the arc extinguishing permanent magnets 143 and 144 are set as shown in FIG. 7 so that opposite end portions of the permanent magnets 143 and 144 in a left-right direction are located slightly on the inner sides of the opposed positions between the contact point portions 118a of the fixed contacts 111 and 112 and the contact point portions of the movable contact 130 respectively. Arc extinguishing spaces 145 and 146 are formed respectively on the outer side of the magnet storage pocket 141 and on the outer side of the magnet storage pocket 142 in the left-right direction.

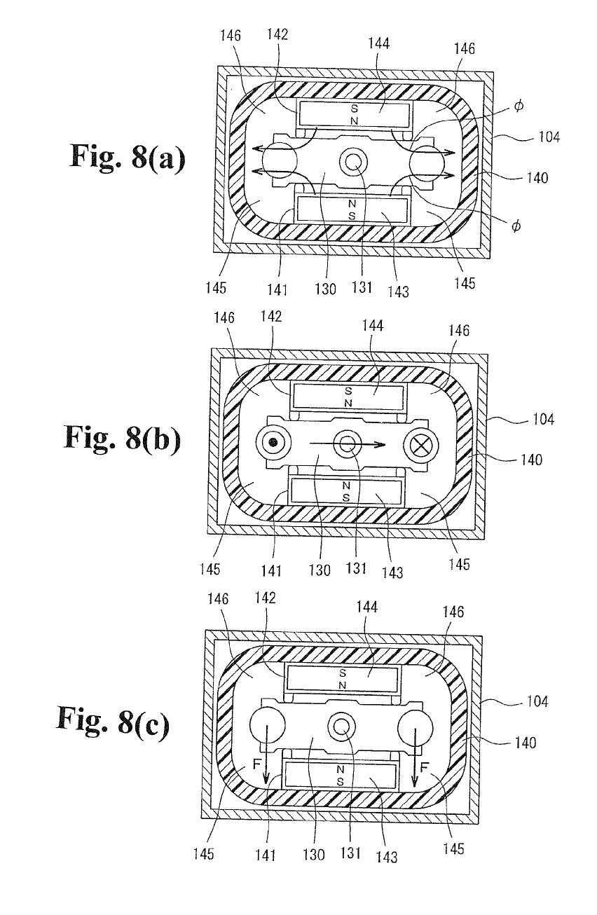

When the arc extinguishing permanent magnets 143 and 144 are disposed thus on the inner circumferential surface side of the insulating cylinder 140, the arc extinguishing permanent magnets 143 and 144 can be close to the movable contact 130. Therefore, as shown in FIG. 8(a), magnetic flux φ emitted from the N pole sides of the two arc extinguishing permanent magnets 143 and 144 crosses the opposed portions between the contact point portions 118a of the fixed contacts 111 and 112 and the contact point portions 130a of the movable contact 130 with a high magnetic flux density so as to go from the inside to the outside in the left-right direction.

Accordingly, when the fixed contact 111 is connected to a current supply source and the fixed contact 112 is connected to a load side, a current in the ON state flows in a direction as shown in FIG. 8(b). That is, the current flows from the fixed contact 111 to the fixed contact 112 via the movable contact 130. When the movable contact 130 is then separated upward from the fixed contacts 111 and 112 and changed from the ON state to the OFF state, arcs are generated between the contact point portions 118a of the fixed contacts 111 and 112 and the contact point portions 130a of the movable contact 130.

These arcs are extended toward the arc extinguishing space 195 on the arc extinguishing permanent magnet 143 side by the magnetic flux φ from the arc extinguishing permanent magnets 143 and 144. On this occasion, due to the arc extinguishing spaces 145 and 146 are formed widely correspondingly to the thicknesses of the arc extinguishing permanent magnets 143 and 144, long arc lengths can be secured for the arcs so that the arcs can be extinguished surely.

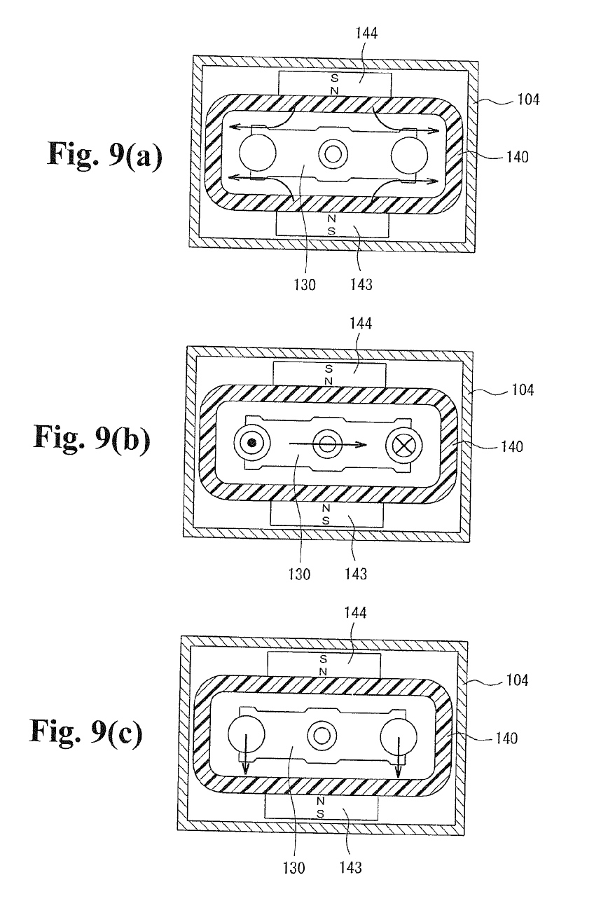

Incidentally, in the case where the arc extinguishing permanent magnets 143 and 144 are located outside the insulating cylinder 140 as shown in FIGS. 9(a) to 9(c), the distances between the arc extinguishing permanent magnets 143 and 144 and the opposed positions between the contact point portions 118a of the fixed contacts 111 and 112 and the contact point portions 130a of the movable contact 130 are elongated so that the density of magnetic flux crossing the arcs is reduced when the same permanent magnets as those in the embodiment are used.

Therefore, a Lorentz force acting on each arc generated in a transition from the ON state to the OFF state is reduced so that the arc cannot be extended sufficiently. It is necessary to increase the amount of magnetization of each of the arc extinguishing permanent magnets 143 and 144 in order to improve the arc extinguishing performance.

Moreover, the depth of the insulating cylinder 140 in a front-rear direction needs to be narrowed in order to shorten the distances between the arc extinguishing permanent magnets 143 and 144 and the contact point portions between the fixed contacts 111 and 112 and the movable contacts 130. There is a problem that sufficient arc extinguishing spaces for extinguishing the arcs cannot be ensured.

However, according to the embodiment, the arc extinguishing permanent magnets 143 and 144 are disposed inside the insulating cylinder 140. Accordingly, all the aforementioned problems caused in the case where the arc extinguishing permanent magnets 143 and 144 are disposed outside the insulating cylinder 140 can be solved.

As shown in FIG. 2, the electromagnet unit 200 has a U-shaped magnetic yoke 201 which is flat in side view. A cylindrical auxiliary yoke 203 is fixed to the center portion of a bottom plate portion 202 of the magnetic yoke 201. A spool 204 as a plunger drive portion is disposed outside the cylindrical auxiliary yoke 203.

The spool 204 includes a central cylinder portion 205 into which the cylindrical auxiliary yoke 203 is inserted, a lower flange portion 206 which protrudes outward in a radial direction from a lower end portion of the central cylinder portion 205, and an upper flange portion 207 which protrudes outward in the radial direction from a slightly lower part of the central cylinder portion 205 than a top end thereof. An excitation coil 208 is wound in a storage space formed by the central cylinder portion 205, the lower flange portion 206 and the upper flange portion 207.

An upper magnetic yoke 210 is fixed between upper ends of the magnetic yoke 201 which serve as open ends. A through hole 210a facing the central cylinder portion 205 of the spool 204 is formed in the center portion of the upper magnetic yoke 210.

The movable plunger 215 is provided to be vertically slidable inside the central cylinder portion 205 of the spool 204. A return spring 214 is provided between a bottom portion of the movable plunger 215 and the bottom plate portion 202 of the magnetic yoke 201. A circumferential collar portion 216 is formed in the movable plunger 215 so as to protrude outward in the radial direction in an upper end portion of the movable plunger 215 protruding upward from the upper magnetic yoke 210.

In addition, a permanent magnet 220 formed annularly is fixed to the upper surface of the upper magnetic yoke 210 so that the permanent magnet 220 surrounds the circumferential collar portion 216 of the movable plunger 215. The permanent magnet 220 has a through hole 221 enclosing the circumferential collar portion 216. The permanent magnet 220 is magnetized, for example, to have an N pole on its upper end side and an S pole on its lower end side in an up-down direction i.e. a thickness direction. Incidentally, the shape of the through hole 221 of the permanent magnet 220 is formed into a shape in accordance with the shape of the circumferential collar portion 216. The shape of an outer circumferential surface of the permanent magnet 220 may be formed into any shape such as a circle or a square.

An auxiliary yoke 225 is fixed to an upper end surface of the permanent magnet 220. The auxiliary yoke 225 is formed into the same outer shape as that of the permanent magnet 220 and has a through hole 224 whose inner diameter is smaller than an outer diameter of the circumferential collar portion 216 of the movable plunger 215. The circumferential collar portion 216 of the movable plunger 215 is facing a lower surface of the auxiliary yoke 225.

In addition, since the permanent magnet 220 is formed annularly, the number of parts can be reduced to thereby achieve reduction of the cost, in comparison with the case where two permanent magnets are disposed symmetrically, for example, as described in JP-A-2-91901 or U.S. Pat. No. 5,959,519. Moreover, since the circumferential collar portion 216 of the movable plunger 215 is disposed in the vicinity of an inner circumferential surface of the through hole 221 formed in the permanent magnet 220, there is no waste in a closed circuit where magnetic flux generated by the permanent magnet 220 passes, so that leakage magnetic flux can be reduced. Thus, the magnetic force of the permanent magnet can be used efficiently.

In addition, the connecting shaft 131 supporting the movable contact 130 is screwed into an upper end surface of the movable plunger 215.

In the OFF state, the movable plunger 215 is urged upward by the return spring 214 so as to be in an OFF position in which an upper surface of the circumferential collar portion 216 abuts against the lower surface of the auxiliary yoke 225. In this state, the contact point portions 130a of the movable contact 130 are separated upward from the contact point portions 118a of the fixed contacts 111 and 112 and brought into a state in which the current is blocked.

In this OFF state, the circumferential collar portion 216 of the movable plunger 215 is attracted to the auxiliary yoke 225 by the magnetic force of the permanent magnet 220. Therefore, in cooperation with the urging force of the return spring 214, the movable plunger 215 is prevented from moving down unexpectedly due to external vibration or shock etc. so that it is possible to keep the state in which the movable plunger 215 is made to abut against the auxiliary yoke 225.

The movable plunger 215 is covered with a cap 230 which is made of a non-magnetic substance and which is formed into a bottomed cylindrical shape. A flange portion 231 formed to extend outward in the radial direction at an open end of the cap 230 is bonded to a lower surface of the upper magnetic yoke 210 by sealing. In this manner, an airtight container in which the arc extinguishing container 102 and the cap 230 communicate with each other through the through hole 210a of the upper magnetic yoke 210 is formed. Gas such as hydrogen gas, nitrogen gas, mixed gas of hydrogen and nitrogen, air, SF₆, etc. is sealed inside the airtight container formed by the arc extinguishing container 102 and the cap 230.

Next, operation of the embodiment will be described.

Assume now that the fixed contact 111 is connected, for example, to a power supply source for supplying a large current and the fixed contact 112 is connected to a load.

Assume that this state is an OFF state in which the excitation coil 208 in the electromagnet unit 200 is non-excited so that no excitation force is generated to move the movable plunger 215 down in the electromagnet unit 200. In this OFF state, the movable plunger 215 is urged upward by the return spring 214 so as to be separated from the upper magnetic yoke 210.

Simultaneously with this, an attracting force caused by the magnetic force of the permanent magnet 220 acts on the auxiliary yoke 225 so that the circumferential collar portion 216 of the movable plunger 215 is attracted to the auxiliary yoke 225. Therefore, the upper surface of the circumferential collar portion 216 of the movable plunger 215 abuts against the lower surface of the auxiliary yoke 225.

Therefore, the contact point portions 130a of the movable contact 130 of the contact mechanism 101 connected to the movable plunger 215 through the connecting shaft 131 are separated upward at predetermined distances from the contact point portions 118a of the fixed contacts 111 and 112. Therefore, a current path between the fixed contacts 111 and 112 is blocked to make the contact mechanism 101 open.

In this manner, both the urging force of the return spring 214 and the attracting force of the annular permanent magnet 220 act on the movable plunger 215 in the OFF state. Accordingly, the movable plunger 215 can be prevented from moving down unexpectedly due to external vibration or shock etc. so that malfunction can be surely prevented.

When the excitation coil 208 of the electromagnet unit 200 is excited in the OFF state, an exciting force is generated in the electromagnet unit 200 so as to push the movable plunger 215 down against the urging force of the return spring 214 and the attracting force of the annular permanent magnet 220.

On this occasion, a magnetic path is formed between the movable plunger 215 and the bottom plate portion 202 of the magnetic yoke 201 through the cylindrical auxiliary yoke 203. Further, a gap between a lower surface of the circumferential collar portion 216 of the movable plunger 215 and the upper magnetic yoke 210 is set to be smaller than a gap between an outer circumferential surface of the movable plunger 215 and the inner circumferential surface of the through hole 210a of the upper magnetic yoke 210. Therefore, the magnetic flux density between the lower surface of the circumferential collar portion 216 of the movable plunger 215 and the upper surface of the upper magnetic yoke 210 becomes larger so that a larger attracting force for attracting the circumferential collar portion 216 of the movable plunger 215 acts.

Accordingly, the movable plunger 215 moves down rapidly against the urging force of the return spring 214 and the attracting force of the annular permanent magnet 220. Thus, the lower surface of the circumferential collar portion 216 abuts against the upper surface of the upper magnetic yoke 210 so that a lower end of the movable plunger 215 is stopped.

When the movable plunger 215 moves down in this manner, the movable contact 130 connected to the movable plunger 215 through the connecting shaft 131 also moves down so that the contact point portions 130a of the movable contact 130 are contacting the contact point portions 118a of the fixed contacts 111 and 112 by the contact pressure of the contact spring 134.

Therefore, provided is a closed state in which the large current from the external power supply source is supplied to the load through the fixed contact 111, the movable contact 130 and the fixed contact 112.

On this occasion, an electromagnetically repulsive force to open the movable contact 130 is generated between each fixed contact 111, 112 and the movable contact 130.

However, as shown in FIG. 2, due to the C-shaped portions 115 formed by the upper plate portions 116, the intermediate plate portions 117 and the lower plate portions 118, the direction of a current flowing in the upper plate portion 116, the lower plate portion 118 and the movable contact 130 opposed thereto in the fixed contact 111 is reverse to the direction of the current flowing in the upper plate portion 116, the lower plate portion 118 and the movable contact 130 opposed thereto in the fixed contact 112.

Therefore, a Lorentz force which presses the movable contact 130 against the contact point portion 118a of each of the fixed contacts 111 and 112 can be generated in accordance with the Fleming's left hand rule based on the relation between the magnetic field formed by the lower plate portion 118 of the fixed contact 111, 112 and the current flowing into the movable contact 130.

The Lorentz force can stand against the electromagnetically repulsive force which is generated between the contact point portions 118a of the fixed contacts 111 and 112 and the contact point portions 130a of the movable contact 130 and which will open the movable contact 130. Accordingly, the contact point portions 130a of the movable contact 130 can be surely prevented from being opened.

Therefore, the pressing force of the contact spring 134 supporting the movable contact 130 can be reduced. In accordance with this, a thrust force generated by the excitation coil 208 can be also reduced so that the overall configuration of the electromagnetic contactor can be made smaller in size.

In order to block the supply of the current to the load in the closed state of the contact mechanism 101, the excitation of the excitation coil 208 of the electromagnet unit 200 is stopped.

Thus, the excitation force to move the movable plunger 215 down in the electromagnet unit 200 disappears so that the movable plunger 215 moves up due to the urging force of the return spring 214 and the attracting force of the annular permanent magnet 220 increases with decrease in distance between the circumferential collar portion 216 and the auxiliary yoke 225.

When the movable plunger 215 moves up, the movable contact 130 connected thereto through the connecting shaft 131 moves up. In accordance with this, the movable contact 130 is contacting the fixed contacts 111 and 112 as long as the contact pressure is given to the movable contact 130 by contact spring 134. After that, as soon as the contact pressure of the contact spring 134 disappears, provided is an open starting state in which the movable contact 130 is separated upward from the fixed contacts 111 and 112.

In the open starting state, arcs are generated between the contact point portions 118a of the fixed contacts 111 and 112 and the contact point portions 130a of the movable contact 130. Current conduction is kept on by the arcs.

On this occasion, since the insulating covers 121 are attached to cover the upper plate portions 116 and the intermediate plate portions 117 of the C-shaped portions 115 of the fixed contacts 111 and 112, arcs can be generated only between the contact point portions 118a of the fixed contacts 111 and 112 and the contact point portions 130a of the movable contact 130. Therefore, the state where the arcs are generated can be stabilized so that the arc extinguishing performance can be improved.

In addition, the upper plate portions 116 and the intermediate plate portions 117 of the C-shaped portions 115 are covered with the insulating covers 121. Therefore, an insulating distance can be secured by the insulating covers 121 between the opposite end portions of the movable contact 130 and the upper plate portions 116 and the intermediate plate portions 117 of the C-shaped portions 115. It is therefore possible to reduce the height of the movable contact 130 in the direction in which the movable contact 130 can move. Accordingly, the size of the contact device 100 can be reduced.

Further, an inner side surface of the intermediate plate portion 117 of the fixed contact 111, 112 is covered with a magnetic substance plate 119. Accordingly, a magnetic field generated by the current flowing in the intermediate plate portion 117 is sealed by the magnetic substance plate 119. Therefore, the magnetic field caused by the arc generated between the contact point portion 118a of the fixed contact 111, 112 and the contact point portion 130a of the movable contact 130 and the magnetic field generated by the current flowing in the intermediate plate portion 117 are prevented from interfering with each other so that the arc can be prevented from being affected by the magnetic field generated by the current flowing in the intermediate plate portion 117.

On this occasion, the opposed magnetic pole faces of the arc extinguishing permanent magnets 143 and 144 have the same polarity, i.e. serve as N poles, and S poles are disposed outside the N poles. Thus, the magnetic flux emitted from each N pole travels from inside to outside in the longitudinal direction of the movable contact 130 and across the portion where the arc is generated between the respective arc extinguishing permanent magnets 143 and 144 the contact point portion 118a of the fixed contact 111 and the contact point portion 130a of the movable contact 130, and reaches the S pole, in a plan view as shown in FIG. 8(a). Thus, a magnetic field is formed.

Similarly, the magnetic flux emitted from each N pole travels from inside to outside in the longitudinal direction of the movable contact 130 and across the portion where the arc is generated between the contact point portion 118a of the fixed contact 112 and the contact point portion 130a of the movable contact 130, and reaches the S pole. Thus, a magnetic field is formed.

Accordingly, the direction of the magnetic flux of each arc extinguishing permanent magnet 143, 144 crossing between the contact point portion 118a of the fixed contact 111 and the contact point portion 130a of the movable contact 130 is reverse to the direction of the magnetic flux of the other arc extinguishing permanent magnet 143, 144 crossing between the contact point portion 118a of the fixed contact 112 and the contact point portion 130a of the movable contact 130 in the longitudinal direction of the movable contact 130.

Therefore, between the contact point portion 118a of the fixed contact 111 and the contact point portion 130a of the movable contact 130, a current I flows into the movable contact 130 side from the fixed contact 111 side and the direction of the magnetic flux φ goes from inside to outside, as shown in FIG. 8(b). Therefore, according to the Fleming's left hand rule, a large Lorentz force F acts toward the arc extinguishing space 145 perpendicularly to the longitudinal direction of the movable contact 130 and perpendicularly to the opening/closing direction between the contact point portion 118a of the fixed contact 111 and the movable contact 130, as shown in FIG. 8(c).

By the Lorentz force F, the arc generated between the contact point portion 118a of the fixed contact 111 and the contact point portion 130a of the movable contact 130 is extended so largely that the arc from a side surface of the contact point portion 118a of the fixed contact 111 passes through the arc extinguishing space 145 and reaches the upper surface side of the movable contact 130. Thus, the arc can be extinguished.

In addition, magnetic flux on the lower side and the upper side of the arc extinguishing space 145 is inclined to the lower side and the upper side with respect to the direction of the magnetic flux between the contact point portion 118a of the fixed contact 111 and the contact point portion 130a of the movable contact 130. Therefore, the arc extended to the arc extinguishing space 145 is further extended toward corners of the arc extinguishing space 145 by the inclined magnetic flux so that the length of the arc can be elongated. Thus, excellent blocking performance can be obtained.

On the other hand, between the contact point portion 118a of the fixed contact 112 and the movable contact 130, the current I flows into the fixed contact 112 side from the movable contact 130 side and the direction of the magnetic flux φ turns to right and travels from inside to outside, as shown in FIG. 8(b).

Therefore, according to the Fleming's left hand rule, a large Lorentz force F acts toward the arc extinguishing space 145 perpendicularly to the longitudinal direction of the movable contact 130 and perpendicularly to the opening/closing direction between the contact point portion 118a of the fixed contact 112 and the movable contact 130.

By the Lorentz force F, the arc generated between the contact point portion 118a of the fixed contact 112 and the movable contact 130 is extended so largely that the arc from the upper surface side of the movable contact 130 passes through the arc extinguishing space 145 and reaches the side surface side of the fixed contact 112. Thus, the arc can be extinguished.

In addition, as described above, magnetic flux on the lower side and the upper side of the arc extinguishing space 145 is inclined to the lower side and the upper side with respect to the direction of the magnetic flux between the contact point portion 118a of the fixed contact 112 and the contact point portion 130a of the movable contact 130.

Therefore, the arc extended to the arc extinguishing space 145 is further extended toward corners of the arc extinguishing space 145 by the inclined magnetic flux so that the length of the arc can be elongated. Thus, excellent blocking performance can be obtained.

On the other hand, when the ON state of the electromagnetic contactor 10 is changed to the OFF state in the state where a regenerative current flows from the load side to the DC power source side, the Lorentz force F acts on the arc extinguishing space 146 side to extend the arc toward the arc extinguishing space 146 side because the current flows in an opposite direction to the aforementioned direction in FIG. 8(b). Except this, the same arc extinguishing function can be fulfilled.

On this occasion, the arc extinguishing permanent magnets 143 and 144 are disposed inside the magnet storage pockets 141 and 142 formed in the insulating cylinder 140. Accordingly, there is no fear that the arcs directly contact the arc extinguishing permanent magnets 143 and 144. Therefore, the magnetic characteristics of the arc extinguishing permanent magnets 143 and 144 can be kept stable enough to stabilize the blocking performance.

In addition, the inner circumference surface of the metal bucket-shaped body 104 is covered with the insulating cylinder 140 so as to be able to be insulated. Accordingly, there is no short-circuiting of the arcs at the time of blocking the current so that the current can be blocked surely.

Further, the insulation function, the function of positioning the arc extinguishing permanent magnets 143 and 144 and the function of protecting the arc extinguishing permanent magnets 143 and 144 from the arcs can be attained by one insulating cylinder 140. Accordingly, the manufacturing cost can be reduced.

Thus, according to the embodiment, the C-shaped portions 115 of the fixed contacts 111 and 112 and the contact spring 134 giving the contact pressure to the movable contact 130 are disposed in parallel in the contact device 100. Accordingly, the height of the contact mechanism 101 can be reduced in comparison with the case where the fixed contacts, the movable contact and the contact spring are disposed in series. Thus, the size of the contact device 100 can be reduced.

In addition, the arc extinguishing container 102 includes the resin container 103, and the metal bucket-shaped body 104 inserted into the side plate portion 103d of the resin container 103. In addition, the resin container 103 and the bucket-shaped body 104 are fixed to each other by an adhesive agent and the external connection terminals 114 as constituents of the fixed contacts 111 and 112 are retained in the terminal retention plate portion 103c of the resin container 103 by adhesive bonding. Therefore, the resin container 103 and the metal bucket-shaped body 104 can be bonded to each other airtightly by the adhesive agent. Therefore, it is not necessary to use expensive ceramic as the arc extinguishing container but the manufacturing cost of the arc extinguishing container 102 can be reduced greatly.

In addition, the terminal insertion holes 103a and 103b through which the pair of external connection terminals 114 is inserted are formed in the terminal retention plate portion 103c of the resin container 103. The annular ribs 103i serving as annular protruding portions and fitted into the terminal insertion holes 104d formed in the top plate 104a of the bucket-shaped body 104 are formed on the lower end sides of these terminal insertion holes 103a and 103b. Therefore, insulation between the external connection terminals 114 and the bucket-shaped body 104 can be ensured by the annular ribs 103i.

In addition, the insulating cylinder 140 is provided on the inner circumferential surface side of the side plate portion 104b of the bucket-shaped body 104 so that insulation between the fixed contacts 111 and 112 and the bucket-shaped body 104 can be ensured.

Further, the tapered portions 103f each of which is gradually larger in diameter as it goes downward are formed in the pair of terminal insertion holes 103a and 103b of the terminal retention plate portion 103c constituting the resin container 103. The adhesive agent injection portions 103g are formed between the tapered portions 103f and the side plate portion 104b of the bucket-shaped body 104. When an adhesive agent is injected into the adhesive agent injection portions 103g, the adhesive agent can be surely injected and retained between the terminal retention plate portion 103c and the external connection terminals 114. Thus, adhesive bonding between the terminal retention plate portion 103c and the external connection terminals 114 can be performed surely so that airtightness can be ensured.

Further, the adhesive agent injection portion 103m shaped like a wedge in section is also formed in the inner circumferential surface of the side plate portion 103d of the resin container 103. Therefore, when an adhesive agent is injected into the adhesive agent injection portion 103m, the adhesive agent can be surely injected and retained between the resin container 103 and the bucket-shaped body 104 so that adhesive bonding between the resin container 103 and the bucket-shaped body 104 can be performed surely. Thus, airtightness can be ensured.

In addition, the synthetic resin material forming the resin container 103 has a larger amount of slow leak of sealed gas than ceramic. However, when the synthetic resin material is used together with the metal bucket-shaped body, leak performance equivalent to that of ceramic can be ensured.

In addition, in the electromagnet unit 200, the annular permanent magnet 220 magnetized in the moving direction of the movable plunger 215 is disposed on the upper magnetic yoke 210 and the auxiliary yoke 225 is formed on the upper surface of the annular permanent magnet 220. Accordingly, the attracting force for attracting the circumferential collar portion 216 of the movable plunger 215 can be generated by one annular permanent magnet 220.

Accordingly, the movable plunger 215 in the OFF state can be fixed by the magnetic force of the annular permanent magnet 220 and the urging force of the return spring 214 so that the retaining force against malfunction shock can be improved.

In addition, the urging force of the return spring 214 can be reduced so that the total load caused by the contact spring 134 and the return spring 214 can be reduced. Accordingly, the attracting force generated by the excitation coil 208 can be reduced in accordance with the reduction of the total load so that the magnetomotive force of the excitation coil 208 can be reduced. Therefore, the axial length of the spool 204 can be shortened so that the height of the movable plunger 215 of the electromagnet unit 200 in the moving direction thereof can be reduced.

Thus, the height of the movable plunger 215 in the moving direction can be reduced in both the contact device 100 and the electromagnet unit 200. Accordingly, the overall configuration of the electromagnetic contactor 10 can be reduced greatly so that the size of electromagnetic contactor 10 can be reduced.

Further, the circumferential collar portion 216 of the movable plunger 215 is disposed inside the inner circumferential surface of the annular permanent magnet 220. Thus, there is no waste in the closed magnetic circuit where the magnetic flux generated from the annular permanent magnet 220 passes, so that leakage magnetic flux can be reduced. Accordingly, the magnetic force of the permanent magnet can be used efficiently.

In addition, the circumferential collar portion 216 of the movable plunger 215 is disposed between the upper magnetic yoke 210 and the auxiliary yoke 225 formed on the upper surface of the annular permanent magnet 220. Accordingly, the stroke of the movable plunger 215 can be adjusted by the thickness of the annular permanent magnet 220 and the thickness of the circumferential collar portion 216 of the movable plunger 215.

Therefore, the accumulative number of components and the shape tolerance affecting the stroke of the movable plunger 215 can be minimized. In addition, the stroke of the movable plunger 215 is adjusted only by the thickness of the annular permanent magnet 220 and the thickness of the circumferential collar portion 216 of the movable plunger 215. Accordingly, variation in the stroke can be minimized.

Incidentally, the aforementioned embodiment has been described in the case where each of the fixed contacts 111 and 112 as constituents of the contact mechanism 101 is formed into a C-shape. However, the invention is not limited to the configuration of the embodiment but a contact mechanism having any configuration can be used in the invention.

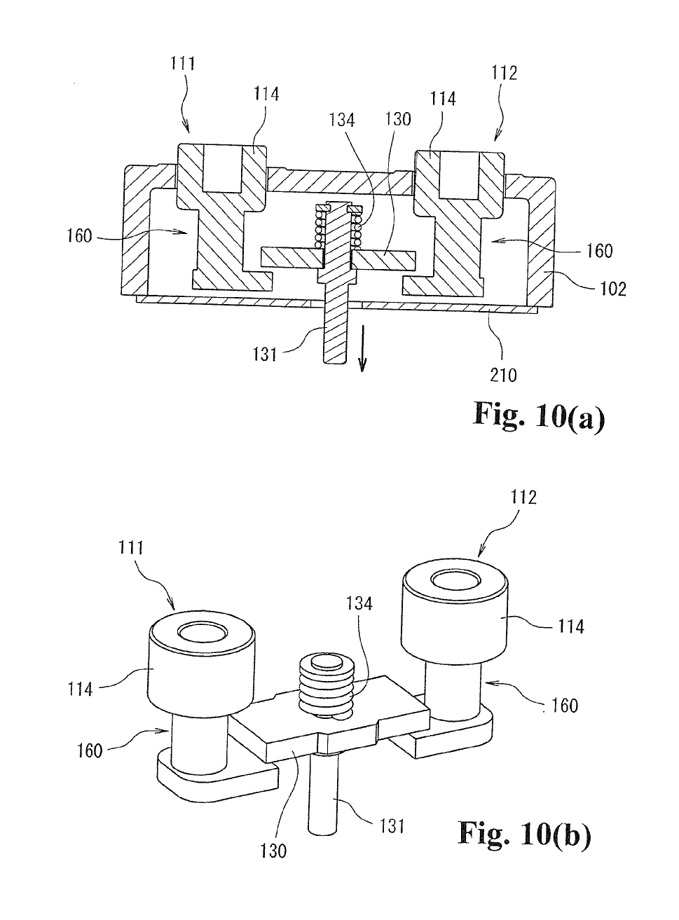

For example, as shown in FIGS. 10(a) and 10(b), an L-shaped portion 160 formed into a shape from which the upper plate portion 116 in the C-shaped portion 115 is removed may be connected to each of the external connection terminals 114. Also in this case, magnetic flux generated by a current flowing into a vertical plate portion of the L-shaped portion 160 can act on a contact portion between each of the fixed contacts 111 and 112 and the movable contact 130 in a closed state in which the movable contact 130 is contacting the fixed contacts 111 and 112. Therefore, the magnetic flux density in each of the contact portions between the fixed contacts 111 and 112 and the movable contact 130 can be increased so that a Lorentz force against an electromagnetically repulsive force can be generated.

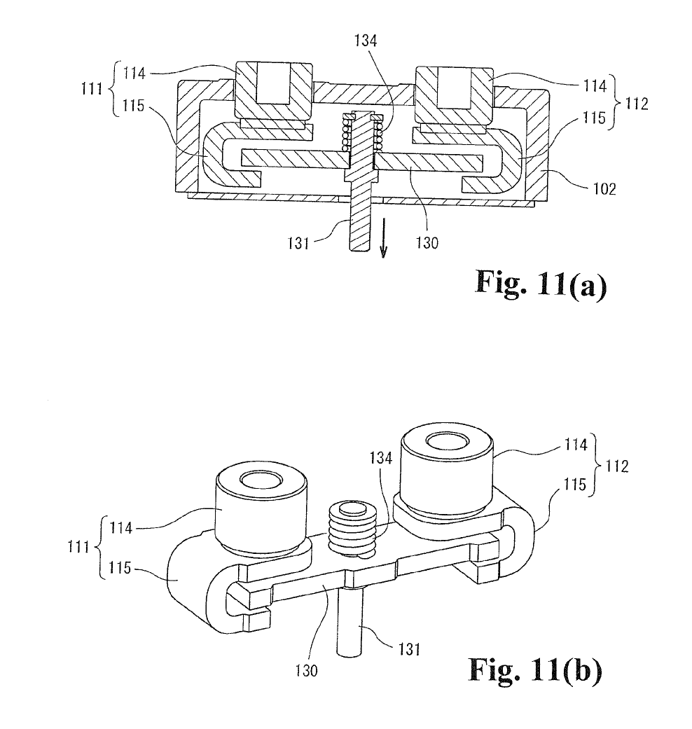

In addition, as shown in FIGS. 11(a) and 11(b), the movable contact 130 may be formed like a flat plate from which the recessed portion 312 is removed.

In addition, the embodiment has been described in the case where the connecting shaft 131 is screwed into the movable plunger 215. However, it is not limited to screwing but any connection method may be used. Further, the movable plunger 215 and the connecting shaft 131 may be formed integrally.

In addition, connection between the connecting shaft 131 and the movable contact 130 has been described in the case where the flange portion 131a is formed in the tip portion of the connecting shaft 131, the connecting shaft 131 is inserted into the contact spring 134 and the movable contact 130 and the lower end of the movable contact 130 is then fixed by means of the C-ring. However, the invention is not limited thereto. That is, configuration may be made in such a manner that after a positioning large-diameter portion protruding in the radial direction is formed in the C-ring position of the connecting shaft 131 and the movable contact 130 is made to abut against the positioning large-diameter portion, the contact spring 134 is then disposed and the upper end of the contact spring 134 is fixed by means of the C-ring.

In addition, although the embodiment has been described in the case where the cylindrical auxiliary yoke 203 is disposed closely to the lower end side of the movable plunger 215, the invention is not limited thereto. That is, as shown in FIGS. 13(a) and 13(b), configuration may be made in such a manner that the magnetic yoke 201 is formed into a bottomed cylindrical shape and the auxiliary yoke 203 includes a ring-like plate portion 203a extending along the bottom plate portion 202 of the magnetic yoke 201, and a cylinder portion 203b rising up from an inner circumferential surface of the ring-like plate portion 203a.

In addition, as shown in FIGS. 14(a) and 14(b), configuration may be made in such a manner that a through hole 202a is formed in the bottom plate portion 202 of the U-shaped upper magnetic yoke 210, a convex auxiliary yoke 203 is fitted into the through hole 202a, and a small diameter portion 203c of the auxiliary yoke 203 is inserted into an insertion hole 217 formed in the movable plunger 215.

In addition, although the embodiment has been described in the case where an airtight container is constituted by the arc extinguishing container 102 and the cap 230 and gas is sealed inside the airtight container, the invention is not limited thereto. Gas sealing may be removed in the case where the current to be blocked is low.

In addition, the embodiment has been described in the case where the arc extinguishing permanent magnets 143 and 144 are disposed on the inner circumferential surface of the insulating cylinder 140. However, the invention is not limited to the aforementioned configuration. The arc extinguishing permanent magnets may be disposed on the outer circumferential surface of the insulating cylinder 140. Further, the arc extinguishing permanent magnets 143 and 144 may be removed.

In addition, the embodiment has been described in the case where rotation of the external connection terminals 114 is prevented by the four positioning pieces 103h formed in the resin container 103 and the engagement grooves 114d formed in each of the external connection terminals 114 and engaged with the positioning pieces 103h. However, the invention is not limited to the aforementioned configuration. Each of the number of positioning pieces 103h and the number of engagement grooves 114d may be one or any plural number except 4. Further, configuration may be made in such a manner that engagement grooves are formed in the resin container 103 and protrusive portions are formed in each of the external connection terminals 114.

In addition, although the embodiment has been described in the case where the invention is applied to an electromagnetic contactor, the invention is not limited thereto but maybe applied to any switch having an arc extinguishing container such as an electromagnetic relay or another switch.

### INDUSTRIAL APPLICABILITY

According to the invention, the metal bucket-shaped body is disposed inside the resin container, and the resin container and the bucket-shaped body are bonded to each other by an adhesive agent. Accordingly, it is possible to provide a switch in which while leak performance equivalent to that of ceramic is attained, a resin container and a bucket-shaped body can be bonded to each other easily so that an arc extinguishing container can be formed easily.

### REFERENCE SIGNS LIST

10 . . . electromagnetic contactor, 11 . . . exterior insulating container, 100 . . . contact device, 101 . . . contact mechanism, 102 . . . arc extinguishing container, 103 . . . resin container, 103a, 103b . . . terminal insertion hole, 103c . . . terminal retention plate portion, 103d . . . side plate portion, 103f . . . tapered portion, 103g . . . adhesive agent injection portion, 103k . . . tapered portion, 103m . . . adhesive agent injection portion, 104 . . . bucket-shaped body, 104a . . . top plate portion, 104b . . . side plate portion, 104c . . . flange portion, 104d . . . terminal insertion hole, 111, 112 . . . fixed contact, 114 . . . external connection terminal, 115 . . . C-shaped portion, 116 . . . upper plate portion, 117 . . . intermediate plate portion, 118 . . . lower plate portion, 118a . . . contact point portion, 121 . . . insulating cover, 122 . . . L-shaped plate portion, 123, 124 . . . side plate portion, 125 . . . fitting portion, 130 . . . movable contact, 130a . . . contact point portion, 131 . . . connecting shaft, 132 . . . recessed portion, 134 . . . contact spring, 140 . . . insulating cylinder, 141, 142 . . . magnet storage pocket, 143, 144 . . . arc extinguishing permanent magnet, 145, 146 . . . arc extinguishing space, 160 . . . L-shaped portion, 200 . . . electromagnet unit, 201 . . . magnetic yoke, 203 . . . cylindrical auxiliary yoke, 204 . . . spool, 208 . . . excitation coil, 210 . . . upper magnetic yoke, 214 . . . return spring, 215 . . . movable plunger, 216 . . . circumferential collar portion, 220 . . . permanent magnet, 225 . . . auxiliary yoke

1. A switch comprising:
a pair of fixed contacts disposed at a predetermined distance from each other;
a movable contact arranged to be capable of contacting with and separating from the pair of fixed contacts; and
an arc extinguishing container internally mounted with the pair of fixed contacts and the movable contact,
wherein the arc extinguishing container further comprises
a resin container having a terminal retention plate portion adhesively bonding a pair of external connection terminals as constituents of the pair of fixed contacts, and a side plate portion extending downward from an outer circumferential portion of the terminal retention plate portion, and formed with an open face on a side opposite to the terminal retention plate portion, and
a metal bucket-shaped body internally mounted with the movable contact and the pair of fixed contacts inserted into the side plate portion of the resin container, and having a lower side opened, and
the arc extinguishing container is formed by bonding the resin container and the metal bucket-shaped body to each other by an adhesive agent.

2. A switch according to claim 1, wherein the terminal retention plate portion includes a pair of terminal insertion holes inserted with the pair of external connection terminals, and a pair of annular protruding portions formed continuously to the pair of terminal insertion holes to protrude from the bottom thereof and fitted into a pair of terminal insertion holes formed in a top plate portion of the bucket-shaped body.

3. A switch according to claim 1, further comprising an insulating cylinder disposed on an inner side surface of the bucket-shaped body, and surrounding the pair of fixed contacts and the movable contact to form an arc extinguishing chamber.

4. A switch according to claim 2, wherein the pair of terminal insertion holes in the terminal retention plate portion of the resin container is formed in a tapered shape each gradually increasing in diameter from an outer surface side toward an inner surface side, and formed with adhesive agent injection portions shaped like a wedge between each of the pair of terminal insertion holes and the external connection terminals.

5. A switch according to claim 1, wherein an inner surface of the side plate portion of the resin container is formed in a tapered shape having an opposing length increasing gradually from the terminal retention plate portion toward the open face, and is formed with an adhesive agent injection portion having a wedge shaped cross-section between the inner surface of the side plate portion and a side surface of the bucket-shaped body.
